(19) United States
(12) Patent Application Publication
(10) Pub. No.: US 2002/0051238 A1
(43) Pub. Date: May 2, 2002

(54) Image reading system

(76) Inventor: Yasuhiro Yamamoto, Tokyo (JP)

Correspondence Address: GREENBLUM & BERNSTEIN, P.L.C., 1941 ROLAND CLARKE PLACE, RESTON, VA, 20191, US

(21) Appl. No.: 09/769,274

(22) Filed: Jan. 26, 2001

(30) Foreign Application Priority Data
Jan. 28, 2000 (JP) P2000-020068

(51) Int. Cl. H04N 1/32

(52) U.S. Cl. 358/468

(57) ABSTRACT

An image reading system comprises an image reading device and a computer connected to the image reading device. A display unit is connected to the computer, and a liquid crystal display is connected to the image reading device. The computer has a video memory in which video data corresponding to an image indicated by the display unit is stored. By operating a switch indicated in a menu image of the display unit, an external monitor mode is set. In the external monitor mode, the video data are read from the video memory and transmitted to the image reading device. Further, in the liquid crystal display unit of the image reading device, the same image as that of the display unit is indicated.

### BACKGROUND OF THE INVENTION

1. Field of the Invention

The present invention relates to an image reading system, provided with an image reading device, which reads an image recorded in a film, for example, using an optical sensor, and a computer, which controls an operation of the image reading device.

2. Description of the Related Art

Conventionally, there is known an image reading system which has an image reading device, in which an image recorded in a film is read by a line sensor, and a computer, which is connected to the image reading device to indicate the image on a screen of a monitor. In the image reading system, the reading operation of the image reading device can be controlled by clicking a mark such as a control bar indicated on the screen of the monitor.

However, if the image reading device and the computer are located at different places and connected through a long cable, the operator must be close to the computer to control the image reading device.

### SUMMARY OF THE INVENTION

Therefore, an object of the present invention is to provide an image reading system in which, even if the image reading device and the computer are located at different places, the operator can handle the image reading device without being close to the computer.

According to the present invention, there is provided an image reading system comprising an image reading device and a computer. The image reading device has a first monitor provided for indicating a first image read by the image reading device. The computer is connected to the image reading device to control the image reading device. The computer has a second monitor for indicating a second image related to a control of the image reading device. The first monitor can also indicate the second image.

Further, according to the present invention, there is provided an image reading system comprising an image reading device and a computer. The image reading device has a first monitor provided for indicating an image read by the image reading device. The computer is connected to the image reading device and has a second monitor by which the image can be indicated. The computer can control the image reading device. The first monitor can indicate the same image as that of the second monitor.

### BRIEF DESCRIPTION OF THE DRAWINGS

The objects and advantages of the present invention will be better understood from the following description, with reference to the accompanying drawings in which:

FIG. 1 is a block diagram showing an image reading device of an embodiment of the present invention;

FIG. 2 is a perspective view of the image reading device observed from a front side;

FIG. 3 is a perspective view of the image reading device observed from a rear side;

FIG. 4 is a perspective view showing a moving mechanism, a light source and a line sensor;

FIG. 5 is a view showing a menu image indicated by a display unit of a computer;

FIG. 6 is a view showing a configuration menu image indicated by a liquid crystal display monitor of the image reading device;

FIG. 7 is a flow chart of a program of an image transmission process which is executed in the computer; and

FIG. 8 is a flow chart of an operation control program which is executed in the image reading device.

### DESCRIPTION OF THE PREFERRED EMBODIMENTS

The present invention will be described below with reference to the embodiments shown in the drawings.

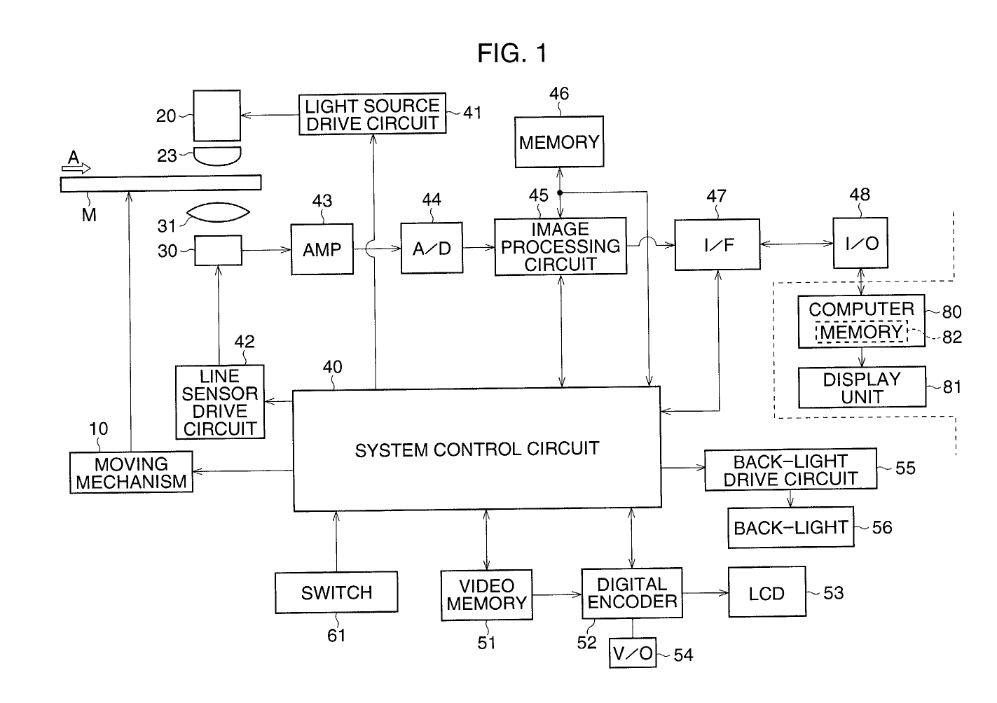

FIG. 1 shows an electrical structure of an image reading device of an embodiment of the present invention.

A read object M, handled by this image reading device, is a transparent negative or positive film on which a color image has been recorded. The film M is intermittently moved, by a moving mechanism 10, in a direction shown by an arrow A.

A light source 20 and a cylindrical lens 23, provided below the light source 20, are disposed above a path along which the film M is moved. A line sensor 30 and a forming lens 31, provided above the line sensor 30, are disposed under the path. The light source 20 is connected to a light source drive circuit 41, so that the light source 20 can be turned ON and OFF. The line sensor 30 is connected to a line sensor drive circuit 42, so that the color image can be read by the line sensor 30. The moving mechanism 10, the light source drive circuit 41 and the line sensor drive circuit 42 are controlled in accordance with a command signal output by a system control circuit 40.

The line sensor 30 is provided with a plurality of photo-diodes, which are aligned rectilinearly, whereby an electric signal, corresponding to the amount of light received by the photo-diode, is generated in each of the photo-diodes. The electric signal (i.e., the image signal), read through the line sensor 30, is amplified by an amplifier 43 and is converted to a digital signal by an A/D converter 44. The digital image data are subjected to an image process, such as a shading correction, in an image processing circuit 45, and are then stored in a memory 46.

The digital image data, subsequent to being read from the memory 46, are subjected to various correction processes, such as a color correction and a gamma correction. Then, the corrected digital image data are converted to video data, which conforms to a predetermined format, by an interface circuit 47, and can be output through an input/output terminal 48 to an external computer 80, which is connected to the image reading device. The image processing device 45 and the interface circuit 47 are controlled by the system control circuit 40.

An internal video memory 51 and a digital encoder 52 are connected to the system control circuit 40, and a liquid crystal display (i.e., a first monitor) 53 and a video output terminal 54 are connected to the digital encoder 52. The image data read from the memory 46 are stored in the video memory 51 in a form of digital R, G and B image data, for example. The image data are converted to analog R, G and B image data in the digital encoder 52, and output to the liquid crystal display 53, so that a color image read by the line sensor 30 is indicated on a screen of the liquid crystal display 53. Further, in the digital encoder 52, a composite video signal is generated based on the image data read from the video memory 51, and output to an external video device (not shown) through the video output terminal 54.

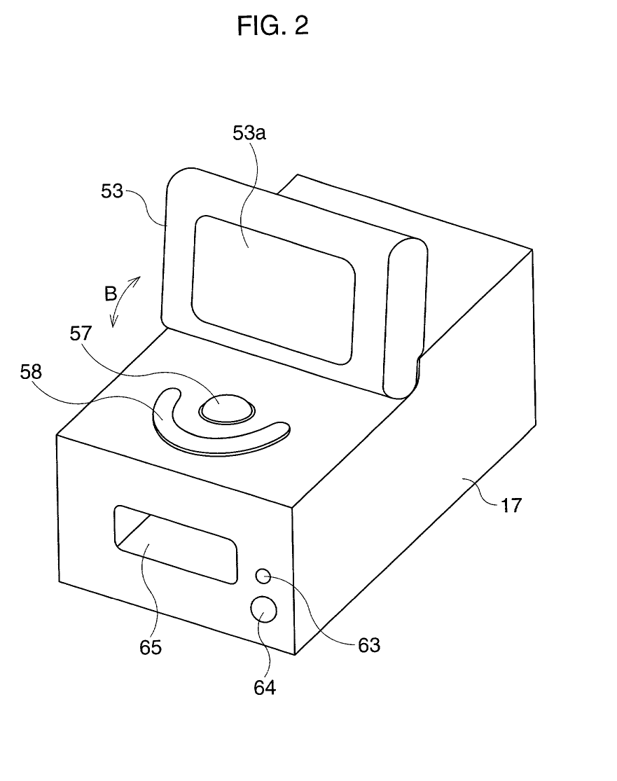

A back-light drive circuit 55 is connected to the system control circuit 40, so that a back-light 56 of the liquid crystal display 53 is turned ON and OFF by the back-light drive circuit 55. A switch 61 provided with a track ball 57 and a click button 58 (see FIG. 2) are connected to the system control circuit 40.

The computer 80 is connected to the input/output terminal 48, so that the operation of the image reading device can be controlled by the computer 80. A display unit (a second monitor) 81 is connected to the computer 80, which is provided with a computer video memory 82 in which video data, corresponding to an image indicated by the display unit 81, is stored. The video data output from the input/output terminal 48 is stored in the video memory 82 and transferred to the display unit 81. Thus, the color image read by the image reading device is indicated by the display unit 81.

The video data of the image indicated by the display unit 81 is transmitted to the image reading device through the input/output terminal 48, and stored in the internal video memory 51. The video data is output to the liquid crystal display 53 through the digital encoder 52, and thus, the same image as that of the display unit 81 of the computer 80 is simultaneously indicated by the liquid crystal display 53.

FIG. 2 is a perspective view of the image reading device observed from a front side.

The liquid crystal display 53 is pivotally attached to an upper surface of a body 17 of the image reading device, and is rotatable along an arrow B. The track ball 57 and the click button 58 are provided on the upper surface of the body 17. The track ball 57 is used for moving a cursor indicated on the screen 53a of the liquid crystal display 53. The click button 58 is used for performing an operation such as a selection of a button indicated on the screen 53a.

An electric power source switch 64 and an indicating lamp 63 are provided on a front surface of the body 17. Further, on the front surface, a film slot 65 is formed, through which the film M (see FIG. 1) is inserted into the body 17.

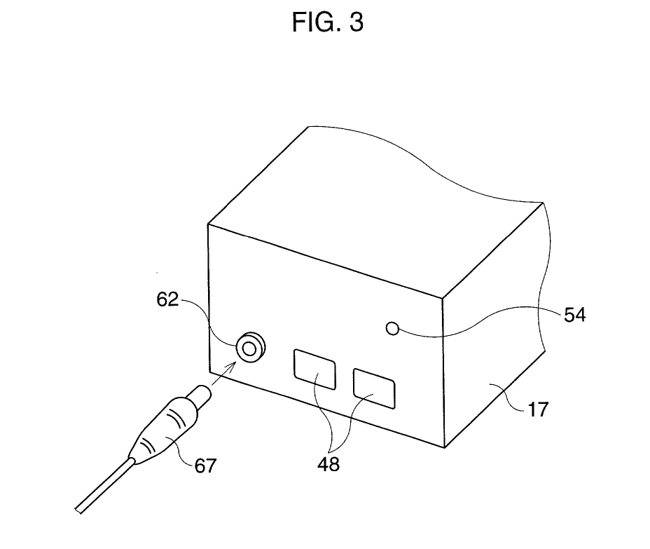

FIG. 3 is a perspective view of the image reading device observed from a rear side.

The video output terminal 54 (see FIG. 1), an electric power supply connector 62 and the input/output terminal 48 (see FIG. 1) are provided on a rear surface of the body 17. A video device is connected to the video output terminal 54 through a cable. An AC adaptor plug 67 is connected to the electric power supply connector 62, and the computer 80 is connected to the input/output terminal 48 through a cable.

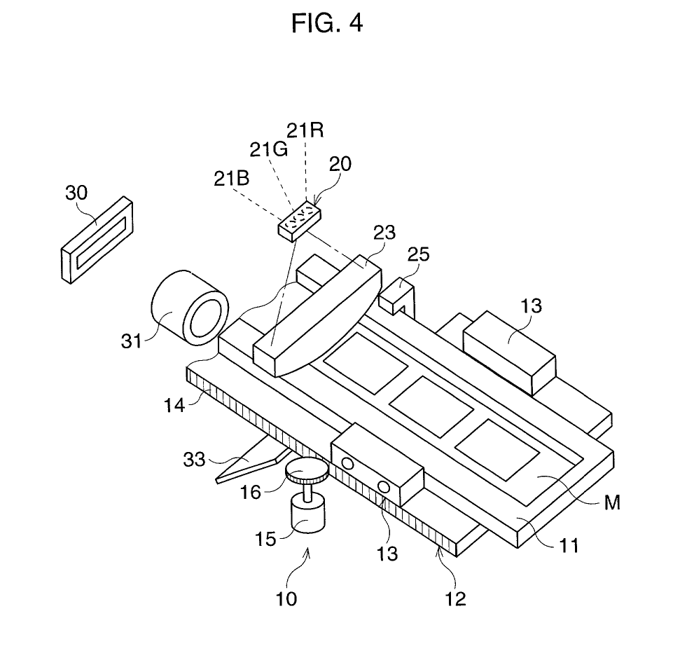

FIG. 4 shows the moving mechanism 10, the light source 20 and the line sensor 30. The negative film M is supported by a frame 11, which is fixed on a plate stage 12 by at least one fastener 13. A frame sensor 25 for sensing the frame 11 is provided close to the stage 12. An opening (not shown) is formed in the stage 12 at a position corresponding to the film M, so that a light beam radiated onto the film M can pass through the film M. A rack 14 is formed on a side surface of the stage 12. A pinion 16 fixed on an output shaft of a feeding motor 15 is meshed with the rack 14. The feeding motor 15, which is a stepping motor, for example, is driven under control of the system control circuit 40, so that the position of the film M is controlled. Thus, the moving mechanism 10 is formed by the rack 14, the feeding motor 15 and the pinion 16.

The light source 20, positioned above the stage 12, is provided with light-emitting diodes 21R, 21G and 21B, which radiate R(red), G(green) and B(blue) light beams, respectively. A cylindrical lens 23, positioned between the light source 2C and the stage 12, is extended in the breadthwise direction of the stage 12.

A mirror 33, which is omitted in FIG. 1, is disposed at a position below the stage 12 and corresponds to the light source 20. The mirror 33 is extended in the breadthwise direction of the stage 12, and in parallel with the cylindrical lens 23. The mirror 33 is inclined at approximately 45 degrees relative to the stage 12. A forming lens 31is disposed under the stage 12 to face the mirror 33. The line sensor 30 is provided behind the forming lens 31, and is extended in parallel to the mirror 33.

When an image recorded in the film M is read, the light-emitting diodes 21R, 21G and 21B are turned ON in a predetermined order under control of the light source drive circuit 41, and thus, a light beam radiated from each of the light-emitting diodes is condensed by the cylindrical leans 23, so that a line-shaped light beam is radiated onto the film M. Thus, the image recorded in the film M is formed on a light receiving surface of the line sensor 30 through the forming lens 31.

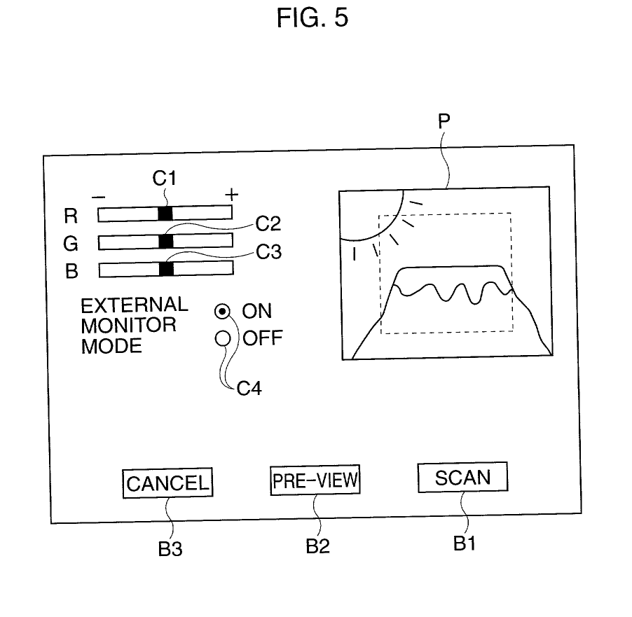

FIG. 5 shows a menu image indicated by the display unit 81 of the computer 80. A pre-view image P, read in a pre-scanning operation by the image reading device, is indicated on an upper-right portion on the menu image, and control bars C1, C2 and C3 are indicated on a left side of the image P. The control bars C1, C2 and C3 are moved rightward and leftward by operating a keyboard or a mouse connected to the computer 80, so that red, green and blue color tones of the pre-view image P are adjusted. A switch C4 for switching the ON-OFF condition of an external monitor mode is provided below the control bars. The switch C4 is switched using the keyboard or the mouse.

When the external monitor mode is turned ON, video data stored in the computer video memory 82 is read and transmitted to the image reading device. Namely, video data of one frame image containing the menu image shown in FIG. 5 and the background around the menu image, are transmitted to the image reading device, so that exactly the same image indicated by the display unit 81 is indicated by the liquid crystal display 53 of the image reading device. Conversely, when the external monitor mode is turned OFF, an image relating to the operation of the image reading device is indicated by the liquid crystal display 53 independently from the computer 80. For example, only the pre-view image P is indicated on the whole surface of the liquid crystal display 53.

A scanning button B1, a pre-view button B2 and a cancel button B3 are provided below the menu image. These command buttons are depressed using the keyboard and the mouse. When the scanning button B1 is depressed, a reading operation of the film M is started in the image reading device. When the pre-view button B2 is depressed, a pre-scanning operation is started in the image reading device. When the cancel button B3 is depressed, the menu image is deleted, so that an operation such as the image reading operation performed by the computer 80 ends.

FIG. 6 shows a configuration menu image indicated by the liquid crystal display monitor 53 of the image reading device. In the drawing, a remote button B4 is indicated on the right side of the “OPERATION MODE” wording. In this state, when depressing the remote button B4 by operating the track ball 57 and the click button 58, the configuration menu is changed to a sub-menu as shown by reference SB, so that an outline enclosing the remote button B4 is changed to a bold line and a stand-alone button B5, enclosed by a thin line, is indicated below the remote button B4. When the remote button B4 is depressed, only the remote button B4 is shown and the remote mode, in which the operation of the image reading device is controlled by the computer 80, is set. Conversely, when the stand-alone button B5 is depressed, only the stand-alone button B5 is shown and the stand-alone mode, in which the image reading device is controlled independently from the computer 80, is set.

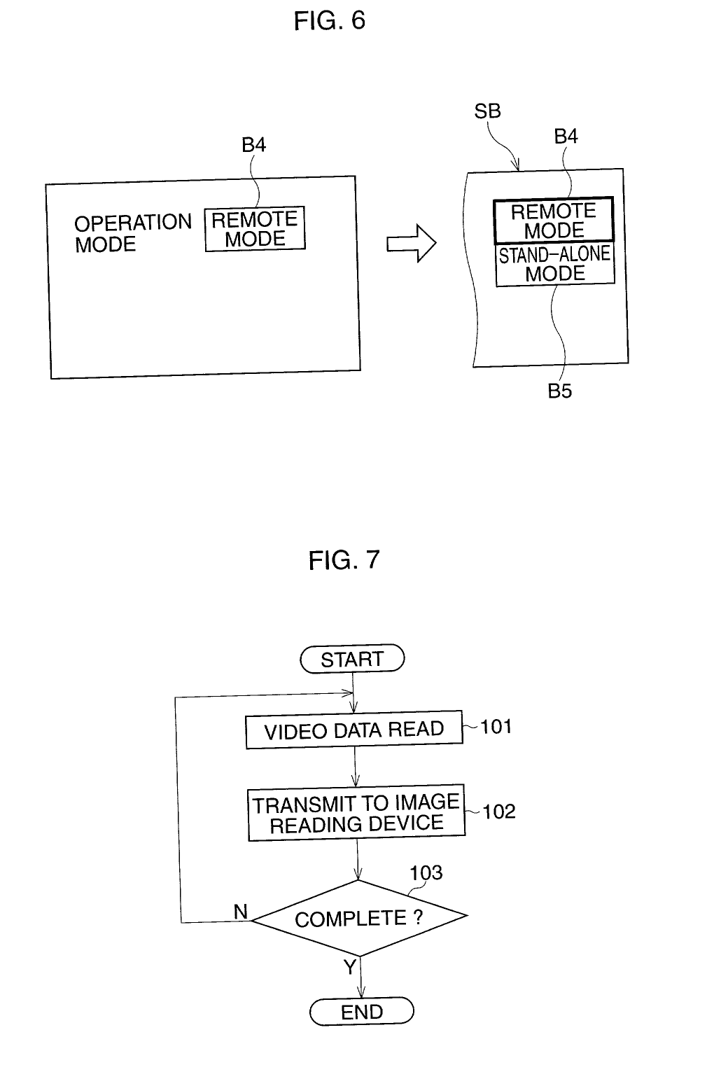

FIG. 7 is a flow chart of a program of an image transmission process which is executed in the computer 80. The image transmission process is executed in interrupt handling at 1/15 second intervals, for example.

In step 101, video data are read by a predetermined amount from the computer video memory 82. In Step 102, the video data read Step 101 are transmitted to the image reading device. In Step 103, it is determined whether the transmission process of the video data of one image has been completed. When the transmission process has not been completed, Step 101 is executed again, and when the transmission process has been completed, the program ends. Note that, when Step 102 is executed for the first time, a write memory command (i.e., a write command signal) is also transmitted to the image reading device together with the video data.

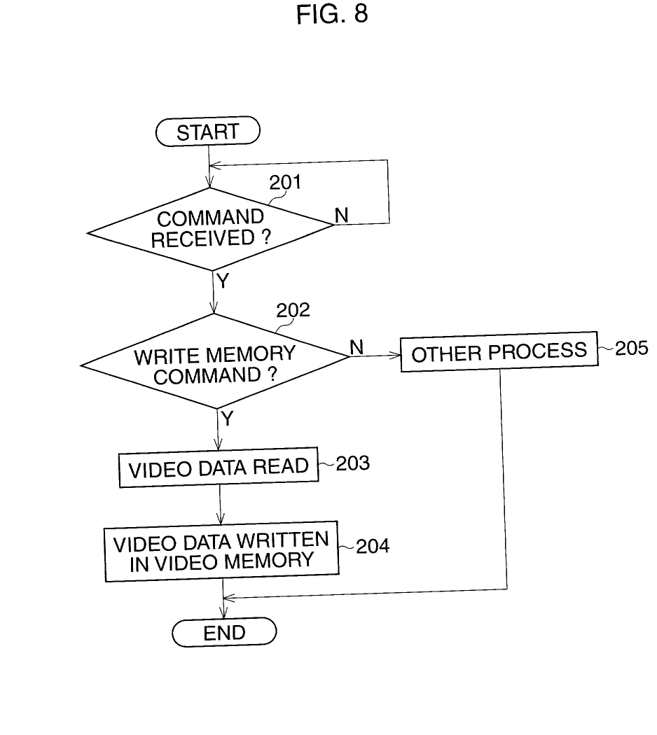

FIG. 8 is a flow chart of an operation control program which is executed in the image reading device. The program is executed when the remote mode described with reference to FIG. 6 is selected.

Step 201 is repeatedly executed until any command, output from the computer 80, is received. When any command is received, it is determined in Step 202 whether the write memory command (i.e., the write command signal) is received. When the write memory command is received, Step 203 is executed in which the video data transmitted from the computer 80 in Step 102 of FIG. 7 are read, and Step 204 is then executed in which the video data are written in the internal video memory 51. The video data written in the video memory 51 are read at a predetermined timing, and are output to the liquid crystal display 53 through the digital encoder 52. Namely, in the liquid crystal display 53, an image corresponding to the video data, i.e., the same image as that of the display unit 81 of the computer 80 is simultaneously indicated as the computer 80.

Conversely, when it is determined in Step 202 that the command received from the computer 80 is not the write memory command, Step 205 is executed in which a process corresponding to the received command is carried out. For example, when a read command is received, a reading operation of the film M by the line sensor 30 is performed in Step 205.

After the execution of Step 204 or 205, the program ends. Then, Step 201 is again executed, so that the process described above is repeated.

As described above, when the switch C4 indicated in the menu image (see FIG. 5) of the display unit 81 of the computer 80 is depressed to set the external monitor mode, the image shown on the display unit 81 is simultaneously indicated in the liquid crystal display 53 of the image reading device. Therefore, for example, even when the image reading device and the computer 80 are positioned at separate places, the operator can observe the pre-view image P (see FIG. 5) while sitting in front of the image reading device, and thus a reading condition such as the white balance adjustment of the film M can be checked.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Applications No. 2000-020068 (filed on Jan. 28, 2000) which is expressly incorporated herein, by reference, in its entirety.

1. An image reading system comprising:
an image reading device that has a first monitor provided for indicating a first image read by said image reading device; and
a computer that is connected to said image reading device to control said image reading device, said computer having a second monitor for indicating a second image related to a control of said image reading device;
said first monitor being able to indicate said second image.

2. An image reading system according to claim 1, wherein said first monitor comprises a liquid crystal display.

3. An image reading system according to claim 1, wherein said computer comprises a computer video memory in which video data, corresponding to said second image, is stored, and a video data transmitting processor that transmits said video data to said image reading device.

4. An image reading system according to claim 3, wherein said image reading device comprises an internal video memory in which said video data transmitted from said computer can be stored.

5. An image reading system according to claim 4, wherein said image reading device comprises a video data writing processor that writes said video data in said internal video memory when receiving a write command signal transmitted from said computer.

6. An image reading system comprising:
an image reading device that has a first monitor provided for indicating an image read by said image reading device; and
a computer that is connected to said image reading device and has a second monitor by which said image can be indicated, said computer being able to control said image reading device;
said first monitor being able to indicate the same image as that of said second monitor.
